(19) United States
(12) Patent Application Publication
(10) Pub. No.: US 2008/0017163 A1
(43) Pub. Date: Jan. 24, 2008

(54) MOUNTING BOARD

(75) Inventors: Wolfgang PETUTSCHING, Graz (AT); Karl KIRCHWEGER, Graz (AT); Rickard STEFANSSON, Goteborg (SE); Bertil ANDERSSON, Kungsbacka (SE)

Correspondence Address: NOVAK DRUCE & QUIGG, LLP, 1300 EYE STREET NW, SUITE 1000 WEST TOWER, WASHINGTON, DC, 20005, US

(73) Assignee: AB VOLVO PENTA, Goteborg (SE)

(21) Appl. No.: 11/306,182

(22) Filed: Dec. 19, 2005

Related U.S. Application Data
(63) Continuation-in-part of application No. PCT/SE04/00913, filed on Jun. 11, 2004.

(30) Foreign Application Priority Data
Jun. 19, 2003 (EP) 03076915.2

(51) Int. Cl. F16M 1/00

(52) U.S. Cl. 123/195 A

(57) ABSTRACT

An internal combustion engine including an engine block provided with an ear portion arranged to carry an auxiliary device driven by a power take off arranged on a crank shaft mounted in said engine block.

### CROSS-REFERENCE TO RELATED APPLICATIONS:

The present application is a continuation patent application of International Application No. PCT/SE2004/000913 filed 11 Jun. 2004 which is published in English pursuant to Article 21(2) of the Patent Cooperation Treaty, and which claims priority to European Application No. 03076915-2 filed 19 Jun. 2003. Said applications are expressly incorporated herein by reference in their entireties.

### TECHNICAL FIELD OF THE INVENTION

The invention relates to an internal combustion engine, and particularly to an internal combustion engine including an engine block provided with an ear portion arranged to carry an auxiliary device.

### BACKGROUND OF THE INVENTION

In known internal combustion engines, auxiliary devices such as fuel pumps, generators and/or compressors are usually fastened to a mounting flange that is configured integral with the engine block. Such an integral mounting flange is conventionally defined as an ear portion. An ear portion is an essentially flat mounting bracket, which is extending in an essentially vertical direction in relation to a length axis of a crank shaft arranged in the combustion engine. The ear portion thereby includes an essentially flat surface extending in a plane vertical to the length axis. The flat surface is used as a base for holding auxiliary devices.

Conventionally, the mounting flange is an integral part of the engine block and is formed when casting the engine block. The ear portion is thus an extension of the die cast engine block. This is a considerable disadvantage with regard to manufacturing engineering, and in particular for engines with large bulk, because the engine block is very difficult to cast as a very large molding box is needed. Furthermore, since the ear portion is relatively thin, it is difficult to make sure that the die is properly filled in the area of the ear and to ensure that the propagation of the flow front in the ear portion is such that colliding flow fronts is avoided when casting the engine block. The difficulty of casting the ear portion results in that the ear portion is sensitive to impact. Furthermore, since the ear portion is extending out from the remaining portion of the engine block, the likelihood of accidental impact is increased. In the event the ear portion is broken, the whole engine block must be rejected.

### SUMMARY OF INVENTION

It is an object of the invention to avoid these drawbacks and to simplify, in an internal combustion engine of the type mentioned herein above, the manufacturing process of the engine block.

By configuring the ear portion as an essentially flat rigid plate which is releasably attached to the engine block in a vertically extending position in relation to the crank shaft, the difficulty of casting of the engine block is substantially diminished. Furthermore, in the event of an accidental impact with a dislocation of the ear portion as a result, the engine block does not have to be rejected since the ear portion could be reinstalled in a correct position.

The flat rigid plate forming the ear portion includes a flat face portion arranged to carry the auxiliary device and edge portions defining the flat face portion. The edge portion is thin in relation to the size of the face portion. A part of the edge portion is attached to the engine block.

In a preferred embodiment, the flat rigid plate is attached to the engine block in a position along the length of the crank shaft such that the power take off and a drive wheel, mounted on the mounting bracket and arranged for propulsion of the auxiliary device, are arranged in a single plane and vertically extending in relation to the crank shaft. This configuration provides for a simple transmission between the drive wheel arranged on the mounting bracket and the crank shaft, since both would be arranged in a single plane.

In another preferred embodiment, an end portion of the essentially flat rigid plate is attached to a recess arranged in the engine block. The recess forms a vertically extending support surface and a longitudinally extending support surface where the vertically extending support surface is arranged for supporting the end portion of one of the main faces of the essentially flat rigid plate. The longitudinally extending support surface is arranged for supporting an edge portion of the essentially flat rigid plate. By arranging the recess, the flat rigid plate can be firmly secured to the engine block even though the plate is vertically attached to the engine block at its end portion.

In a still further preferred embodiment, the end portion is locked at the recess by a clamping member attached to a vertically extending face of the engine block. Preferably, the flywheel casing is used as a clamping member.

In another preferred embodiment, a reduction in the number of engine components is achieved by: extending the flywheel casing, forming a housing for the fly wheel, integrally forming a housing for at least a drive wheel of the auxiliary device, and closing the housing for at least a drive wheel of the auxiliary device with the essentially flat rigid plate.

In a preferred embodiment of the invention, the flat rigid plate extends along and is connected to a main proportion of the height of the engine block in order to ensure that the ear portion should be sufficiently rigidly fixed to the engine block. In a further preferred embodiment where the engine block includes a crank case and a cylinder block and where the engine further includes a cylinder head, the flat rigid plate extends along and is connected to both the crank case and the cylinder block. The cylinder head could optionally be arranged to lock the essentially flat rigid plate from movement in a height direction of the engine.

### BRIEF DESCRIPTION OF THE DRAWINGS

The invention will be explained in greater detail hereinbelow with reference being made to the accompanying drawings, in which:

FIGS. 1 and 2 are perspective views of a first variation of an internal combustion engine configured according to the teachings of the present invention, but taken from different angles;

FIG. 1a is a perspective view showing a rigid plate in detail;

FIG. 3 is a cross-sectional view of the internal combustion engine taken along the line III-III in FIGS. 1 and 2;

FIG. 4 is a cross-sectional view of the internal combustion engine taken along the line IV-IV in FIG. 1;

FIG. 5 is a cross-sectional view of said internal combustion engine taken along the line V-V in FIG. 3;

FIG. 6 is a cross-sectional view analogous to FIG. 3 of a second variant of the internal combustion engine according to the invention; and

FIG. 7 is a cross-sectional view of a detail of said internal combustion engine taken along the line VII-VII in FIG. 6.

### DETAILED DESCRIPTION

In the different embodiments or variations, like elements bear like reference numerals.

The internal combustion engine 1 includes an engine block 2 to which is fastened a cylinder head 3. An intermediate wheel 8, which is driven by a drive wheel 9 of the crankshaft 10 drives an auxiliary device 12, for example a fuel pump through, via a power take off arranged as the drive wheel 9 meshed with the intermediate wheel 8, which is in turn meshed with a driven wheel 11 arranged on a drive shaft 11a. Drive wheel 9, intermediate wheel 8 and driven wheel 11 are configured as spur gears.

The auxiliary device 12 is solidly connected to an ear portion formed as an essentially flat rigid plate 13 that is arranged normal to the axle 10a of the crankshaft and is in turn rigidly connected to the engine block 2. The plate 13 is thereby configured as a separate component and is detachably connected to the engine block 2 in a region adjacent the engine block 2.

The essentially flat rigid plate 13 is attached to the engine block 2 in a position along the length L of the crank shaft 10 such that said power take off 9 and the driven wheel 11, mounted on said rigid plate 13 and arranged for propulsion of said auxiliary device 12, are arranged in single plane P vertically extending in relation to said crank shaft 10. The plane is defined by a surface normal, n, that is parallel to the length axle 10a of the crank shaft 10.

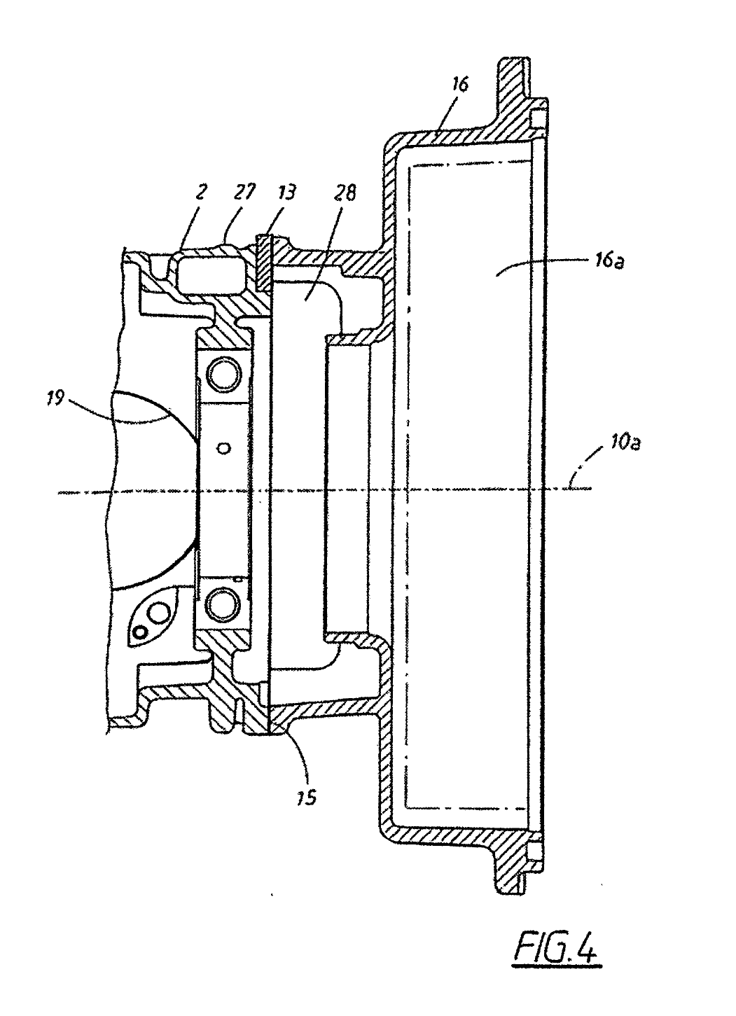

The plate 13 is arranged on a long side 27 of the engine block 2 in the region 14 between the engine block 2 and a housing 16 that is fastened to a vertically extending face 1, 15, preferably the rear end 15 on the engine block 2, said housing 16 being for example housing for a flywheel 16a or a spur gear housing. The vertically extending face can also be arranged in between the rear or front end in the event a power take off is arranged between the rear or front end of the engine block. The plate 13 is clamped between housing 16 and engine block 2 in region 14. The plate 13 is moreover attached to the housing 16 by means of a screwed connection achieved by way of screws that have not been illustrated herein. The corresponding tapping is labeled with the numeral 17. The housing 16 is rigidly connected to the engine block 2 and to the plate 13 (FIG. 5).

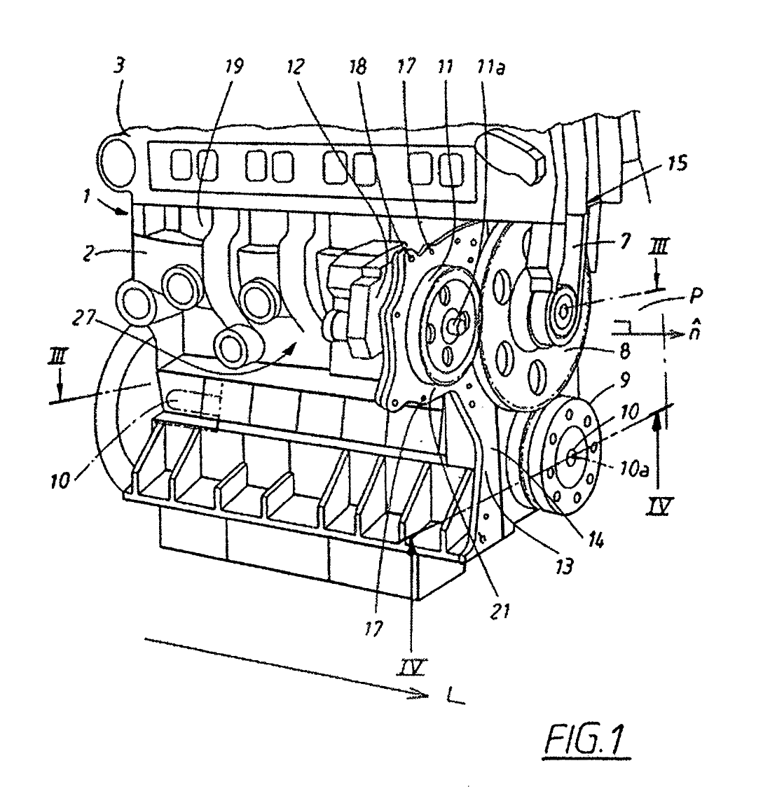

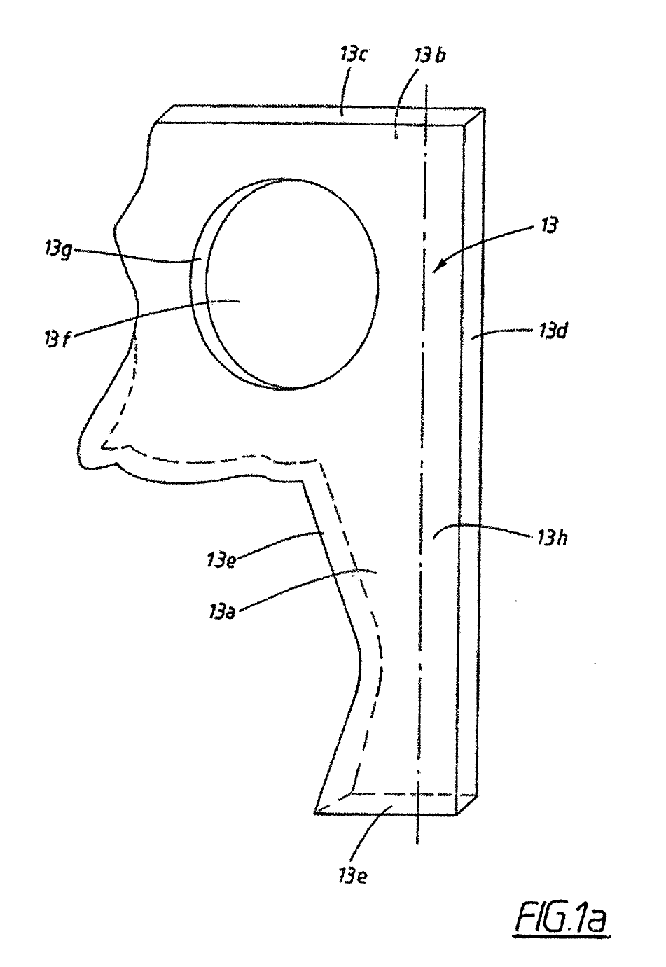

In FIG. 1a, the rigid plate 13 is shown in more detail. The rigid plate comprises two main faces, a front face 13a and a back face. The main faces 13a, 13b are defined by edge portions 13c-13e defining the shape of the rigid plate 13. The rigid plate 13 also includes at least one cut out 13f defined by an internal edge portion 13g. An end portion 13h of one of the main faces 13a, 13b of the essentially flat rigid plate 13 is attached to a recess 14a in said engine block. The recess 14 forms a vertically extending support surface 14b and a longitudinally extending support surface 14c. The vertically extending support surface 14b is arranged for supporting the end portion 13h and the longitudinally extending support surface is arranged for supporting an edge portion 13d of said essentially flat rigid plate 13.

In one embodiment of the invention, the flywheel casing 16 extends, to in addition to housing a flywheel 16a, to integrally form a housing 16b for at least a drive wheel 11 of said auxiliary device 12, and that said housing 16b for at least a drive wheel 11 of said auxiliary device 12 is closed by said essentially flat rigid plate 13.

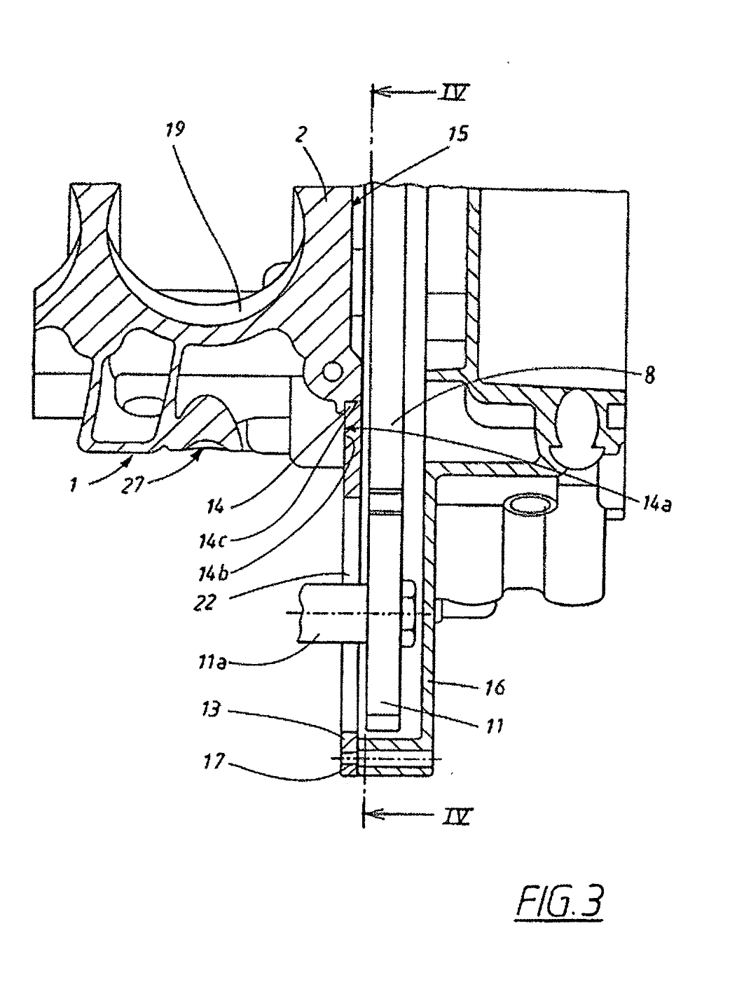

As may be seen from FIGS. 4 and 5, the housing 16 comprises a top aperture 28 for valve driving means that have not been illustrated herein. Another bottom aperture 29 enables oil return to an oil pan that is not shown in the Figs.

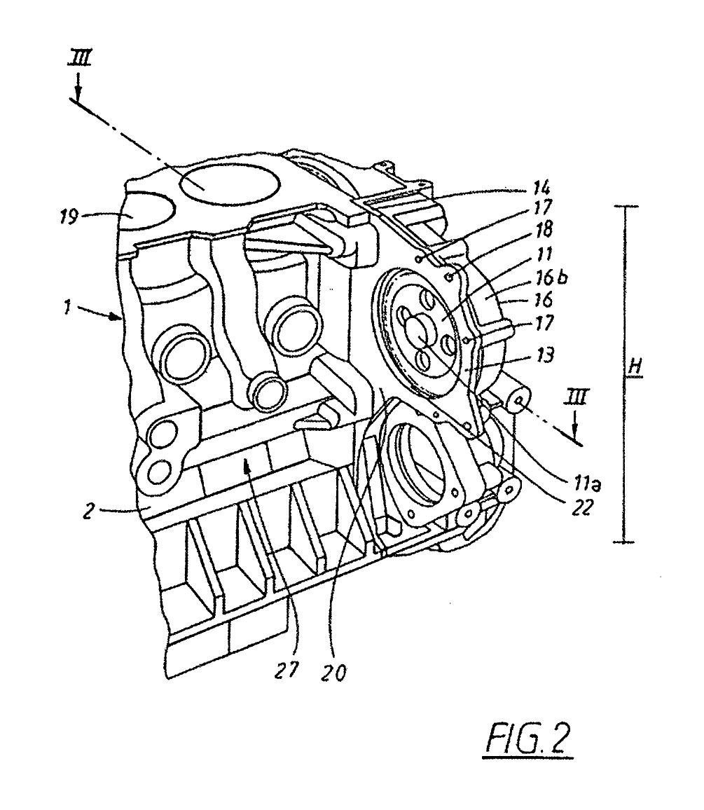

In the embodiment illustrated in the FIGS. 1 through 3, the auxiliary device 12 is arranged on that side 20 of the mounting board 13 that faces the cylinders 19 and is directly fastened to the mounting board 13. The mounting bores 18 serve to fasten the auxiliary device 12 to the mounting board 13 by means of screws that have not been illustrated herein. The mounting plate 13 is provided with a mounting aperture 22 for the driven wheel 11.

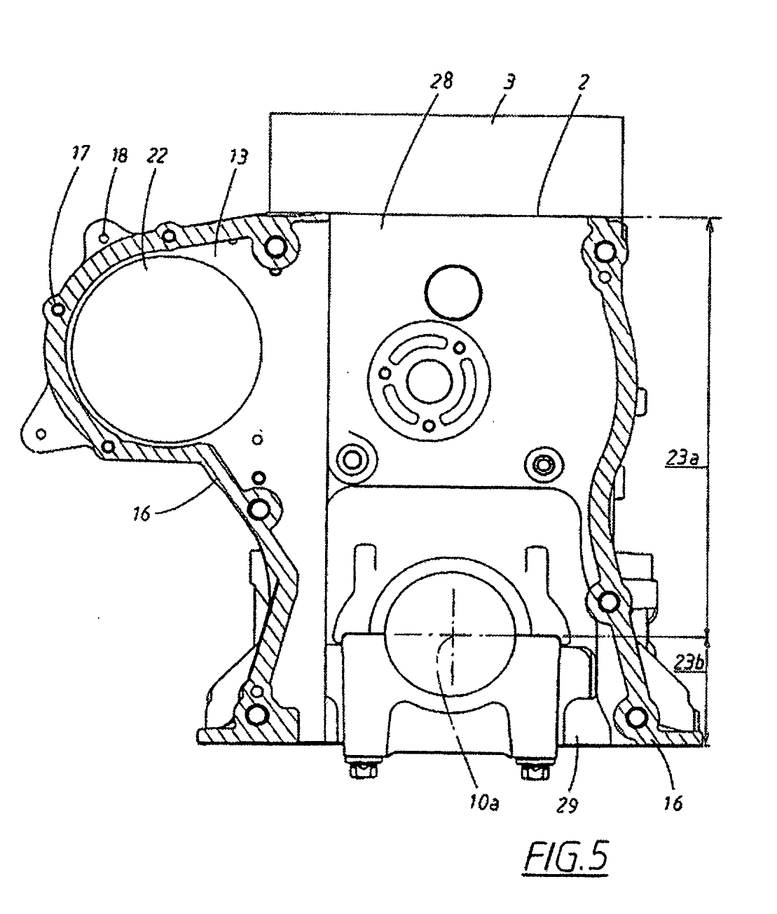

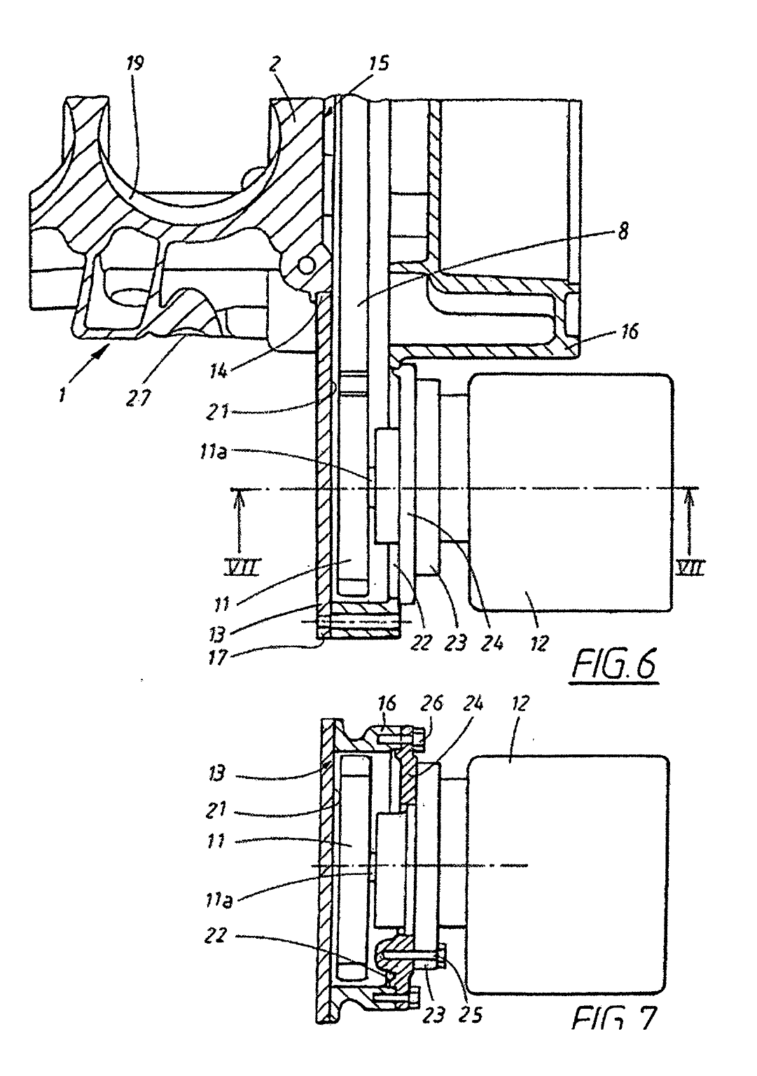

On the other hand, FIGS. 6 and 7 show an embodiment in which the auxiliary device 12 is arranged on the side 21 that faces the housing 16 and is fastened to the housing 16. Since in this embodiment the mounting aperture 22 for the driven wheel which is arranged in the housing 16 is larger than the mounting flange 23 of the auxiliary device 12, an interfacial flange 24 is arranged between auxiliary device 12 and housing 16. The auxiliary device 12 is fastened to the interfacial flange 24 by way of screws 25 and said interfacial flange is in turn connected to the housing 16 with screws 26. In this embodiment, the plate 13 is substantially configured as a solid body—that is to say without a mounting aperture for the driven wheel 11.

The housing 16 in FIG. 1 and the auxiliary device 12 in FIG. 2 have been dismounted for purposes of clarity. In FIG. 2, the cylinder head has been omitted as well.

As may be seen from FIG. 1, the plate 13 is configured as a level steel plate and extends over the entire height H of the engine block 2. As a result thereof, the flange facing for the auxiliary device 12 is guaranteed to be rigid and torsion resistant.

As seen in FIG. 5, in the event the engine block 2 includes a crank case 23b and a cylinder block 23a, the essentially flat rigid plate 13 preferably extends along and is connected to both the crank case 23b and cylinder block 23a.

Furthermore, a cylinder head 3 could be arranged to lock the essentially flat rigid plate 13 from movement in a height direction of said engine.

The plate 13, which is configured as a separate component part, makes certain of a reliable and rigid fixation of the auxiliary device 12 on the engine block 2 on one side and permits easy casting of the engine block 2 on the other.

What is claimed is:

1. An internal combustion engine (1) comprising:
an engine block (2) provided with an ear portion (13) arranged to carry an auxiliary device (12) driven by a power take off (9) arranged on a crank shaft (10) mounted in said engine block (2); and
said ear portion (13) is configured as an essentially flat rigid plate releasably attached to said engine block (2) in a vertically extending position in relation to said crank shaft (2) and said plate is vertically attached to said engine block (2).

2. The internal combustion engine as recited in claim 1, wherein said essentially flat rigid plate (13) is attached to said engine block (2) in a position along the length of the crank shaft (10) such that said power take off (9) and a drive wheel (11), mounted on said rigid plate (13) and arranged far propulsion of said auxiliary device (12), are arranged in a single plane (P) vertically extending in relation to said crank shaft (10).

3. The internal combustion engine as recited in claim 1, wherein an end portion (1 3h) of one of the main faces (1 3a, 13b) of the essentially flat rigid plate (13) is attached to a recess (14a) in said engine block, which recess (14a) forms a vertically extending support surface (14b) and a longitudinally extending support surface (14c), where the vertically extending support surface (14b) supports the end portion (13h) and the longitudinally extending support surface (14c) supports an edge portion (13d) of said essentially flat rigid plate (13).

4. The internal combustion engine as recited in claim 3, wherein said end portion (13h) is locked at said recess (14a) by a clamping member attached to a vertically extending face of said engine block (2).

5. The internal combustion engine as recited in claim 4, wherein said damping member is constituted by a flywheel casing.

6. The internal combustion engine as recited in claim 5, wherein said flywheel casing extends to in addition to house a flywheel, integrally form a housing for at least a drive wheel (11) of said auxiliary device (12), and that said housing for at least a drive wheel (11) of said auxiliary device (12) is closed by said essentially fiat rigid plate (13).

7. The internal combustion engine as recited in claim 1, wherein said essentially flat rigid plate (13) extends along and is connected to a main proportion of the height of the engine block (2).

8. The internal combustion engine as recited in claim 7, wherein said engine block (2) includes a crank case (2b) and a cylinder block (2a), characterized in that said essentially flat rigid plate (13) extends along and is connected to both the crank case (2b) and cylinder block (2a).

9. The internal combustion engine as recited in claim 8, wherein said engine further includes a cylinder head, characterized in that said cylinder head locks said essentially flat rigid plate from movement in a height direction of said engine.
